(19) United States
(12) Patent Application Publication
(10) Pub. No.: US 2011/0056088 A1
(43) Pub. Date: Mar. 10, 2011

(54) Method for Reducing Runnability Problems Caused By Gas Flows in an Impingement Dryer for a Fibre Web and an Impingement Dryer

(75) Inventors: Petri Norri, Turku (FI); Hans Sundqvist, Turku (FI)

(73) Assignee: Metso Paper, Inc., Helsinki (FI)

(21) Appl. No.: 12/989,004

(22) PCT Filed: Apr. 20, 2009
(86) PCT No.: PCT/FI2009/050292

§ 371 Date: Nov. 24, 2010

(30) Foreign Application Priority Data
Apr. 21, 2008 (FI) 20080300

(51) Int. Cl. F26B 25/06

(52) U.S. Cl. 34/217; 34/210

(57) ABSTRACT

The invention relates to an impingement dryer and a method for reducing runnability problems caused by gas flows in an impingement dryer for a fibre web, which impingement dryer has gas blowing opening and gas exhaust openings. The fibre web to be dried is supported with a support fabric. The support fabric and the fibre web to be dried are moved in the machine direction inside the impingement dryer past the blowing openings and exhaust openings. At the same time hot gas is blown from the blowing openings toward the fibre web to be dried and gas is removed from the vicinity of the fibre web to the exhaust openings. At least one edge control strip is moved in the machine direction edges of the impingement dryer in front of the blowing openings or the exhaust openings or both. With its aid a desired number of blowing openings or exhaust openings or both are covered and thus their effect is controlled.

### CROSS REFERENCE TO RELATED APPLICATIONS

This is a U.S. national stage of application No. PCT/FI2009/050292, filed on Apr. 20, 2009. Priority is claimed on Finland, Application No. 20080300, filed Apr. 21, 2008. The content of both applications are incorporated herein by reference.

### BACKGROUND OF THE INVENTION

1. Field of the Invention

The object of the invention is a method and an impingement dryer according to the preambles of the independent claims presented further below. The invention relates especially to a new way of arranging impingement drying for heating and drying a web travelling in the drying section of a paper machine or the like.

2. Description of Prior Art

An impingement dryer according to prior art comprises a web run arrangement, which supports the paper web, and a blow chamber, which on the side toward the web has blowing means for blowing air or another hot gas toward the paper web. Generally the web run arrangement comprises several subsequent rolls and cylinders, which are mainly fixed in their place but arranged to rotate around their longitudinal axis, a support fabric, such as a wire, which is arranged to move in relation to the rolls and cylinders, and runnability components, such as blow boxes. The paper web is typically arranged to travel past the blowing means of the impingement dryer, supported on the rolls, the cylinders, the wire and the runnability components. The blowing means generally comprise a blow surface, which has blow openings, from which hot air is led toward the paper web. The impingement dryer also usually comprises air exhaust means for removing air from the dryer. The air exhaust means can for example be suction openings arranged in the blow surface, through which openings air is suctioned.

Impingement dryers can be divided into vertical and horizontal ones, according to the position of their web run arrangement and thus also the main position of the paper web transported in them. In vertical impingement dryers hot air is blown into the paper web while the web travels in a mainly vertical position. In horizontal impingement dryers hot air is blown into the paper web while the web travels in a mainly horizontal position. Vertical and horizontal must be understood widely, comprising up to a 45° deviation from the vertical or horizontal direction. The deviation can also be 0-35°, 0-20°, 0-10° or 0-5 degrees. The position of the web run arrangement and the paper web within one impingement dryer can be essentially straight or somewhat curved.

Impingement dryers have been presented for example in the patent publications WO 97/13031, WO 02/36880 and WO 2005/068713.

Runnability problems typical for paper machines, caused for example by air flows, occur in impingement dryers. The paper web is typically somewhat narrower than the support fabric supporting it. The blow extending over the edge of the web causes air flows, which can lift the edge of the web off the support fabric. This can cause edge defects in the paper web and even web breaks. Also a too narrow blow zone, i.e. a situation, where the blowing does not extend sufficiently close to the edge of the web, can also cause the edge of the paper web to detach from the support fabric, as well as insufficient drying of the paper web at its edge areas.

The runnability problems caused by air flows are possible especially when the web and the support fabric are transported in the impingement dryer using so-called unsupported draw. By unsupported draw is meant that the web and the support fabric are supported on the roll or cylinder a little at the most, for example when the travel direction of the web is turned inside the dryer.

If the blow extends over the edge of the web, the support fabric may be damaged. The temperature of the part of the support fabric underneath the paper web cannot exceed the temperature of the web, which is typically about 45-90° C. when in use. The temperature naturally depends on the process parameters. The temperature of the part of the support fabric which extends over the edges of the web can however rise beyond the limit allowed by the manufacturing material of the support fabric, if the blowing of hot air is directed straight onto it.

The width of the web to be dried can vary, for example when changing from one paper grade to another. There is thereby a danger that the blows are not directed to the desired optimal area on the web. Also when installing the impingement dryer and in connection with maintenance work, the blows need to be adjusted to the correct area.

### SUMMARY OF THE INVENTION

It is an object of the present invention to reduce or even eliminate the above-mentioned problems appearing in the prior art.

It is especially an object of the present invention to provide a solution, wherewith the runnability problems caused by air flows in an impingement dryer can be reduced.

It is especially an object of the present invention to provide a solution, wherewith the detachment of the edges of a web to be dried in an impingement dryer from the support fabric can be reduced.

It is especially an object of the present invention to provide a solution, wherewith edge defects of a web to be dried in an impingement dryer and web run breaks can be reduced.

It is especially an object of the present invention to provide a solution, wherewith the quality of the drying of the edge areas of a web to be dried in an impingement dryer is improved.

It is especially an object of the present invention to provide a solution, wherewith the runnability problems caused by air flows can be reduced in an impingement dryer, where a web to be dried is transported at least mainly using unsupported draw, i.e. without supporting the web and the support fabric on a roll or cylinder.

The embodiment examples and advantages mentioned in this text relate, where applicable, to both the method and the impingement dryer according to the invention, even if this is not always specifically mentioned.

In a typical method according to the invention the runnability problems caused by gas flows are reduced in a fibre web impingement dryer, which has gas blowing means and gas exhaust means. By a fibre web is meant for example a pulp web or a paper web. The typical method comprises at least the following steps:
The fibre web to be dried is supported with a support fabric, such as a wire.
The support fabric and the fibre web to be dried are moved in the machine direction, supported by several rolls or cylinders, which rotate around axes in the cross machine direction:
   a) in through the first end of the impingement dryer,
   b) inside the impingement dryer past the blowing means and exhaust means, and
   c) out through the second end of the impingement dryer.
Hot gas, for example air, is blown from the blowing means toward the fibre web to be dried. For example when drying a paper web, the temperature of the gas to be blown can be for example 200-400° C.
The gas is removed from the vicinity of the fibre web to the exhaust means.
The effect of the blowing means or exhaust means or both is controlled in the machine direction edges of the impingement dryer by moving at least one edge control strip in front of them, with the aid of which a desired number of blowing means or exhaust means or both are covered.

A typical impingement dryer according to the invention is used to dry a continuous fibre web, such as a paper or pulp web. The web is supported with a support fabric, such as a wire. Both the support fabric and the web it supports are moved through the impingement dryer in its machine direction. A typical impingement dryer according to the invention comprises:
A first and a second end of the impingement dryer, which are essentially in the cross machine direction, and edges essentially in the machine direction.
Gas blowing means and gas exhaust means arranged inside the impingement dryer. The gas to be blown is typically heated air. Part of the gas can be brought from outside the impingement dryer and part can be circulated inside the device from the exhaust means back to the blowing means.
Several rolls or cylinders, which are arranged to rotate around their longitudinal axis, which is in the cross machine direction, on which rolls or cylinders the support fabric and the fibre web to be dried are arranged to move. The rolls or cylinders are arranged to define the path, along which the support fabric and the fibre web are arranged to travel:
   a) in through the first end of the impingement device,
   b) inside the impingement device past the blowing means and exhaust means, and
   c) out through the second end of the impingement dryer.

Movable edge control strips are arranged in the machine direction edges in order to control the effect of the blowing means or exhaust means or both in the machine direction edge areas of the impingement dryer. The edge control strips are arranged to be movable to a desired position in front of the blowing means and exhaust means in the edge areas. Thus the gas blowing means or exhaust means or both can be covered as desired. Runnability problems caused by gas flows can thus be reduced. The width of the edge control strip can be for example 50-500 mm, 100-250 mm or 100-150 mm. The width of the zone in the machine direction in one or both of the machine direction edges of the impingement dryer, in which zone the air flows can be controlled with the edge control strip, can be for example 50-500 mm, 100-250 mm or 100-150 mm.

In an embodiment of the invention the impingement dryer is vertical. In a vertical impingement dryer hot air is blown into a fibre web, such as a paper web, while the web travels in a mainly vertical position. In an embodiment of the invention the impingement dryer is horizontal. In a horizontal impingement dryer hot air is blown into a fibre web, such as a paper web, while the web travels in a mainly horizontal position. Vertical and horizontal must be understood widely, comprising up to a 45° deviation from the vertical or horizontal direction. The deviation can also be 0-35°, 0-20°, 0-10° or 0-5 degrees.

In an embodiment of the invention the path of the support fabric and the fibre web inside one impingement dryer can be essentially straight or somewhat curved. A curved path is arranged for example so that the web is transported via several rolls and supported by the rolls, whereby the direction of the web is turned slightly at each roll. Between the rolls the support fabric and the web travel along an essentially straight path.

In an embodiment of the invention the controllable edge control strips according to the invention are placed in both of the machine direction edges of the impingement dryer. Typically both of the edge control strips can be controlled independently, i.e. irrespective of each other.

In an embodiment of the invention the edge control strips according to the invention are movable in a stepless manner. If the edge control strips are movable in steps, the steps can be for example 20-50 mm or about 25 mm.

The edge control strip can be arranged to be movable either in the machine direction, in the cross machine direction or essentially diagonally in relation to both the machine direction and the cross machine direction. It is also possible to arrange the edge control strip to be movable in two different directions, for example in the machine direction and the cross machine direction. Thus the position of the edge control strip can be controlled relatively freely in relation to the web to be dried.

In an embodiment of the invention there is a planar blow surface inside the impingement dryer, wherein blow openings of the blowing means and exhaust openings of the exhaust means are formed. Thus the edge control strip is moved in the direction of the blow surface.

In an embodiment of the invention there is at least one blow chamber of the dryer inside the impingement dryer. The planar blow surface is arranged on the side of the blow chamber, which is meant to be toward the paper web.

In an embodiment of the invention the edge control strip is moved between the blow surface and the fibre web to be dried. Thus the edge control strip is easy to service.

In an embodiment of the invention the edge control strip is moved on the side of the blow surface which is opposite to the fibre web to be dried, i.e. on the blow chamber's side of the blow surface. Thus the edge control strip is inside the blow chamber, where it can be protected for example from fouling caused by the fibre web to be dried.

In an embodiment of the invention the edge control strip is used to cover mainly only blow openings in its various positions. This reduces detachment of the web from the support fabric in many situations. At the same time the amount of air escaping from the edge of the dryer is reduced.

In an embodiment of the invention the edge control strip is used to cover mainly only suction openings in its various positions. This is advantageous when a lot of blowing is needed in the edge areas of the web.

In an embodiment of the invention the blow openings of the blow surface are arranged into at least two elongated zones in the machine direction, whereby the placement of the blow openings varies in the different zones. Thus
The blow openings in the edge area of the blow surface define a first blow opening zone. A desired number of the blow openings in the first blow opening zone are covered with the edge control strip according to the invention.
The blow openings in the middle part of the blow surface, i.e. those around the central line of the impingement dryer, define a second blow opening zone. Blow openings in the second blow opening zone cannot be covered with the edge control strip according to the invention.

The blow openings of the second blow opening zone can for example be arranged as evenly as possible on the blow surface, with an even distance between them. The blow openings of the first blow opening zone can on the other hand be arranged for example into particular rows or groups, which align with the openings in the edge control strip, which is moved in front of them, in a desired manner.

In an embodiment of the invention the web to be dried is transported in the impingement dryer using at least mainly unsupported draw, i.e. without supporting the web and support fabric with rolls. There may still be several rolls in the impingement dryer supporting the support fabric and the web, but their purpose is thus essentially for example to turn the travel direction of the web.

In an embodiment of the invention there are runnability components, such as blow or suction boxes, inside the impingement dryer, wherewith the movement of the fibre web is controlled. The runnability components can be used for example to stabilize the travel of the support fabric of the dryer and the web during the unsupported draws between the rolls of the dryer.

In an embodiment of the invention the edge support strip is kept in an inclination of 0.1-2 degrees or 0.2-0.5 degrees in relation to the machine direction. When the fibre web dries it typically becomes somewhat narrower and by turning the edge strip the blowing can be controlled precisely to be in the direction of the edge of the web.

In an embodiment of the invention indentations, located in the cross machine direction, are formed in the edge strip for reducing thermal tensions which are directed onto it. The edge strip is often substantially colder at its outer edge than at the edge toward the inner part of the dryer, which can cause large stresses to the metallic strip.

In an embodiment of the invention the movement of the edge control strip is controlled manually, for example by hand or with the aid of an electric motor. The movement can be controlled for example by turning a lever by hand, which lever is connected to the edge control strip via a cable wire or the like. The edge control strip can also be connected to a control motor, for example an electric step motor, using which the location of the edge control strip can be altered.

In an embodiment of the invention the movement of the edge control strip is controlled with an automatic control system. The automatic control system can comprise for example
at least one sensor, which produces measurement data, which sensor can be any sensor suitable for the purpose, such as a monitoring device operating by the optic principle or a sensor monitoring mechanical movement;
a control device, such as a computer, and a program used therewith, which transforms the measurement data obtained from the sensor into control data for the control motor;
data transfer devices, such as wire or wireless data transfer devices for transmitting the measurement data from the sensor to the computer and for transmitting the control data from the computer to the control motor, which moves the edge control strip.

In an embodiment of the invention the automatic control system is arranged to monitor the location of the edge of the fibre web to be dried in the dryer. Thus the sensor produces measurement data for the edge, i.e. data regarding the location of the edge of the fibre web. The control device produces control data for the control motor based on the measurement data for the edge. The purpose is thus that the automatic control system moves the edge strip to an optimal area in relation to the edge of the fibre web.

In an embodiment of the invention the automatic control system is arranged to monitor the position of the devices which delimit the edge of the fibre web to be dried, such as so-called edge cutters. Thus the sensor produces measurement data regarding the position of the edge cutters, i.e. so-called position data. Such a sensor can for example be mechanically connected to the edge cutters, so that anytime the edge cutters move, the sensor senses the movement of the edge cutters via the mechanical contact. The purpose is thus that the automatic control system moves the edge strip to an optimal area in relation to the position of the device which delimits the fibre web, such as the edge cutter.

### BRIEF DESCRIPTION OF THE FIGURES

The invention is described in more detail below with reference to the enclosed schematic drawing, in which

FIG. 1 shows one impingement dryer according to the invention,

FIG. 2 shows a cross-section in the machine direction of an impingement dryer according to the invention,

FIGS. 3A and 3B show the function of an edge control strip according to the invention,

FIGS. 4A and 4B show the function of an edge control strip according to the invention,

FIG. 5 shows the function of an edge control strip according to the invention,

FIGS. 6A, 6B, 6C, 7A, 7B and 7C show the function of different edge control strips according to the invention,

FIG. 8 shows an edge control strip according to the invention,

FIGS. 9A and 9B show the function of an edge control strip according to the invention,

FIG. 10 shows the control mechanism of an edge control strip of the invention,

FIGS. 11A and 11B show the function of an edge control strip according to the invention,

FIGS. 12A and 12B show the function of an edge control strip according to the invention,

FIG. 13 shows a method according to the invention as a flow chart; and

FIG. 14 is a block diagram of components used in the method of FIG. 13.

### DETAILED DESCRIPTION OF THE EXAMPLES OF THE FIGURES

For the sake of clarity, the same reference number is used for some corresponding parts in different embodiments in the figures.

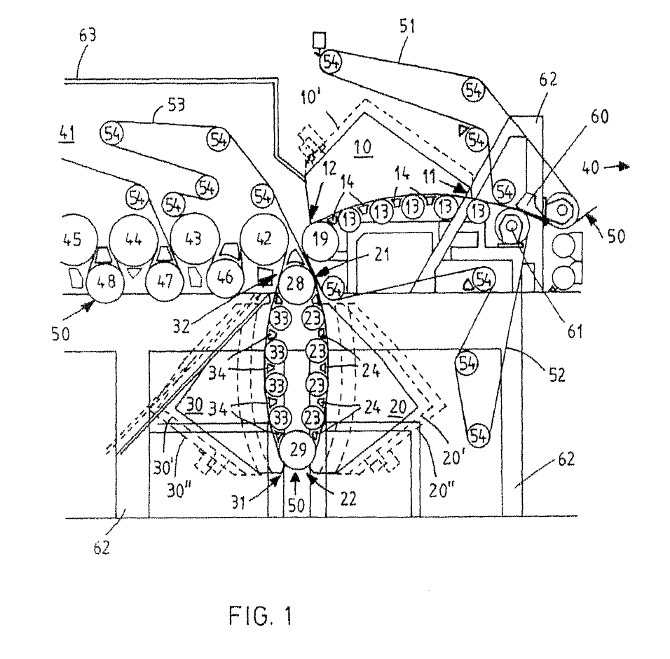

FIG. 1 show both two typical so-called vertical impingement dryers 20, 30 according to the invention and a so-called horizontal impingement dryer 10. The impingement dryers 10, 20, 30 are installed in the forward end of the drying section 41 of a paper machine, before the drying cylinders 42-45. The paper web 50 to be dried is, supported by the first wire 51, directed from the press section 40 with the aid of a runnability component 60 to the roll 61 and to be supported by the second wire 52. Thereafter the paper web 50 is, supported by the second wire 52, led in through the first end 11 of the horizontal impingement dryer 10. Inside the dryer 10 the second wire 52 and the paper web 50 travelling with it are transported substantially horizontally, supported by rotating support rolls 13 and blow boxes 14. When moving horizontally the paper web 50 is subjected to the drying of the horizontal impingement dryer 10. The second wire 52 and the paper web 50 to be dried are, supported by the roll 19, led out through the second end 12 of the horizontal impingement dryer 10. Thereafter the path of the second wire 52 and the paper web 50 is turned downwards and further onto the roll 28. On the roll 28, the paper web 50 to be dried is changed to be supported by the third wire 53. From the roll 28 the third wire 53 and the paper web 50 supported by it are led in through the first end 21 of the first vertical impingement dryer 20. Inside the dryer 20 the third wire 53 and the paper web 50 travelling with it are transported substantially vertically downwards, supported by rotating support rolls 23 and blow boxes 24. When moving downwards the paper web 50 is subjected to the drying of the first vertical impingement dryer 20. The third wire 53 and the paper web 50 are led out through the second end 22 of the first vertical impingement dryer 20 to the turn roll 29 at the bottom end of the dryer 20. With the aid of the roll 29 the travel direction of the third wire 53 and the paper web 50 is turned back upwards, and in through the first end 31 of the second vertical impingement dryer 30. Inside the dryer 30 the third wire 53 and the paper web 50 travelling with it are transported substantially vertically upwards, supported by rotating support rolls 33 and blow boxes 34. When moving upwards the paper web 50 is subjected to the drying of the second vertical impingement dryer 30. The third wire 53 and the paper web 50 are led out through the second end 32 of the second vertical impingement dryer 30 and via the roll 28 to the first drying cylinder 42 of the drying section 41 of the paper machine. In FIG. 1 has also been drawn the subsequent drying cylinders 43, 44 and 45 and the turn rolls 46, 47 and 48 of the drying section 41.

In the example in FIG. 1 the paper web 50 travels along a somewhat curved web run inside both the vertical 20, 30 and the horizontal impingement dryer 10. The curved web run is achieved by placing the axes of the rolls 13, 23, 33, which support the paper web 50 and the wire 51-53 by the dryer, in a curved line as seen from the cross machine direction. The web run of the paper web 50 and the wire 51-53 turns slightly by each of these rolls 13, 23, 33. In the sections between these rolls 13, 23, 33 the wire and the web travel with unsupported draw, i.e. supported by the blow boxes 14, 24, 34 along an essentially straight web run.

In FIG. 1 alternative positions 10′, 20′, 20″, 30′, 30″ of the dryers are drawn with dotted lines, into which alternative positions the dryers can be moved for example for the duration of maintenance work. Typically when moving the dryer 10, 20, 30 to its alternative position 10′, 20′, 20″, 30′, 30″ the wire 51-53 and the paper web 50 by it do not move with the dryer. In the alternative positions 10′, 20′, 20″, 30′, 30″ the dryer with its blow chamber and blowing means is thus moved further from the support rolls 13, 23, 33, from the paper web 50 to be dried and from the wire 51-53 than in a normal running situation. In FIG. 1 some support structures 62 of the paper machine and the hood 63 of the drying section can also be seen.

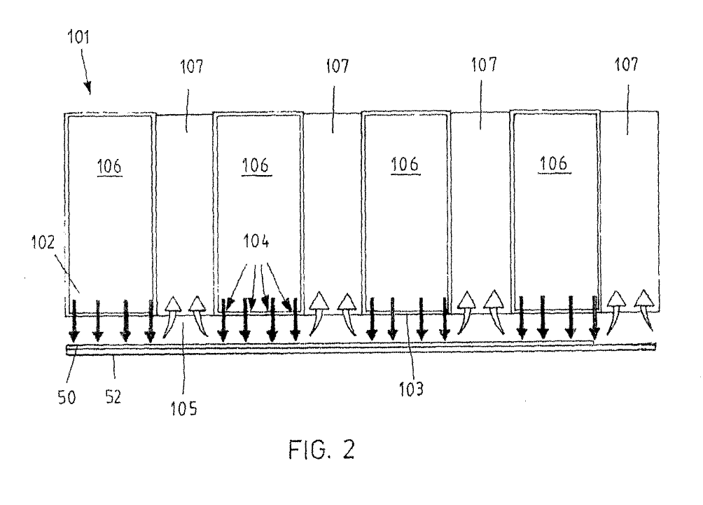

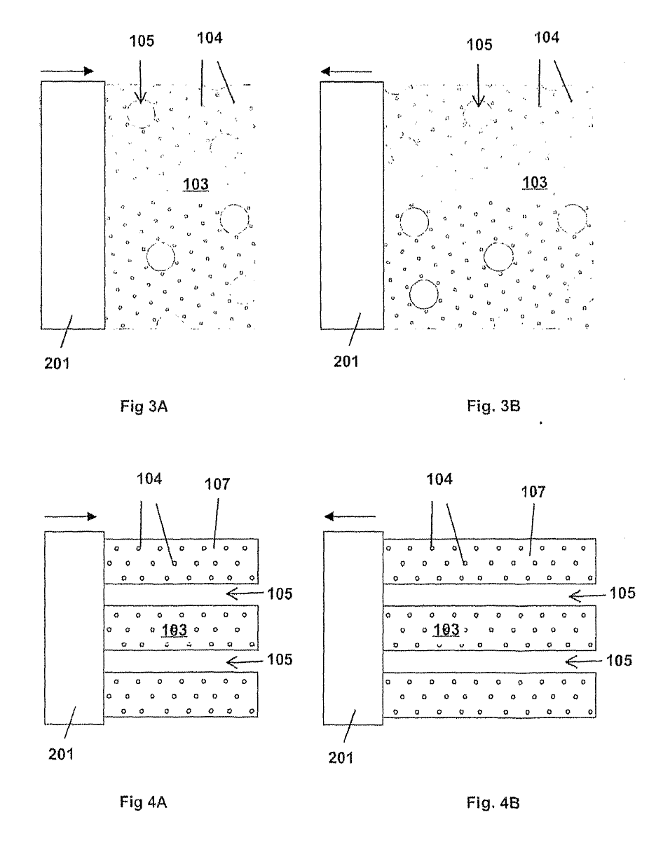

The blow chambers 101 of the dryers are inside the dryers 10, 20, 30, in the sides toward the paper web 50 of which chambers blowing means 102 are arranged for blowing air or another hot gas toward the paper web 50, which travels past them. The structure of one blow chamber 101 is shown in FIG. 2. The blowing means 102 comprise a blow surface 103, which has blow openings 104, from which the hot air is led toward the paper web 50. Exhaust means for the air, i.e. exhaust openings 105, have also been arranged in the blow surface 103, through which openings air is suctioned out from the dryer 10, 20, 30. Some possible details of the structures of the blow surface are shown in FIGS. 3-9.

FIG. 2 shows a partial cross-section in the machine direction of a blow chamber 101 of a horizontal impingement dryer 10 according to the invention. In the bottom edge of the figure is shown the paper web 50 to be dried and underneath it the support fabric supporting it, i.e. the wire 52. Above the web 50, at a distance of for example 10-50 mm or 20-30 mm, there is a blow surface 103, which is parallel to the web 50 and the support fabric 52. Above the blow surface 103 there are air inlet ducts 106, from which heated air is blown through the blow openings 104 formed in the blow surface 103 toward the web 50 to be dried in the manner shown by the arrows. The moisture goes from the web 50 to be dried into the air. Between the air inlet ducts 106 there are air exhaust ducts 107, into which moist air is suctioned through the exhaust openings 105 formed in the blow surface 103 from the vicinity of the web 50 to be dried.

FIGS. 3-9 show various solutions for adjusting the blows and suctions in the machine direction edge part of the impingement dryer with an edge control strip 201 according to the invention. In some figures the directions, in which the edge control strip 201 can be moved in the situation of each figure in order to control the blows and suctions, are marked schematically with arrows. The examples in the FIGS. 3-9 are depicted so that the machine direction is in the vertical direction of the sheet.

FIGS. 3A and 3B show how the edge control according to the invention takes place by moving the strip 201 in the cross machine direction, which strip covers the blow openings 104 and exhaust openings 105 in the edge area of the blow surface 103 as needed. In FIG. 3A the control strip 201 has been moved to its extreme position towards the central line of the machine, which is to the right in the figure. Thus the strip 201 covers the blow surface 103 over the entire edge area. FIG. 3B shows how the edge strip 201 has been pulled to its extreme position to the side, i.e. away from the central line of the machine, whereby the entire blow surface 103 is visible.

The example in FIGS. 4A and 4B corresponds to the example in FIGS. 3A and 3B, with the exception of the shape of the exhaust openings 105. The blow and exhaust openings can be circular openings, such as in FIGS. 3A and 3B or straight gaps, such as the exhaust openings 105 in FIGS. 4A and 4B, i.e. the so-called suction gaps.

In the examples in FIGS. 3 and 4 the movable strip 201 is shown as a solid plate. It is possible that the edge strip 201 is for example a solid steel plate. Thus it covers the entire blow surface 103 over the area of the entire strip 201. Because the blow openings 104 and the exhaust openings 105 are in the examples in FIGS. 3 and 4 interlocked, both the blow openings 104 and the suction openings 105 are covered under the strip 201 in these examples. Since the relationship between the exhaust and the suction thus remains largely the same in the edge area of the paper web 50 to be dried regardless of the position of the strip 201, it is possible to effectively eliminate air flows in the edge area of the web 50.

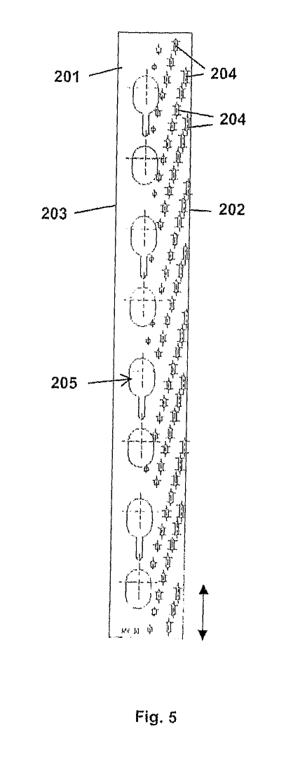

FIG. 5 shows an edge control strip 201, which is moved in the longitudinal direction of the machine. The strip 201 is formed so that when it is moved, only a desired number of the blow openings 104 of the blow surface 103 are covered. In the first edge 202 of the strip, in the right edge in the figure, blow openings 204 of the strip are arranged in rows, which are diagonal both in relation to the longitudinal direction of the machine and to the cross machine direction. Depending on the position of the strip 201 in relation to the blow surface 103, all or only a part or none of the blow openings 104 under the strip 201 align with the blow openings 204 of the strip. In the second edge 203 of the strip, in the left edge in the figure, suction openings 205 of the strip are formed, the suction openings being somewhat elongated in the longitudinal direction of the machine. The suction openings 205 of the strip are formed so that even if the strip is moved within the operational limits of its setting in the machine direction, the exhaust openings 105 in the edge area of the blow surface 103 always align with the suction openings 205 of the strip, whereby the suction functions in the edge area of the blow surface 103 at all times. The amount of air suctioned from the edge area does thus not essentially depend on the settings of the blow zone formed by the blow openings 104, i.e. on the position of the strip 201. This way is advantageous in a situation, where it is desirable to ensure that enough hot air is suctioned from the edge area of the impingement dryer 10, 20, 30, for example in order to minimize the amount of hot air leaking to the outside.

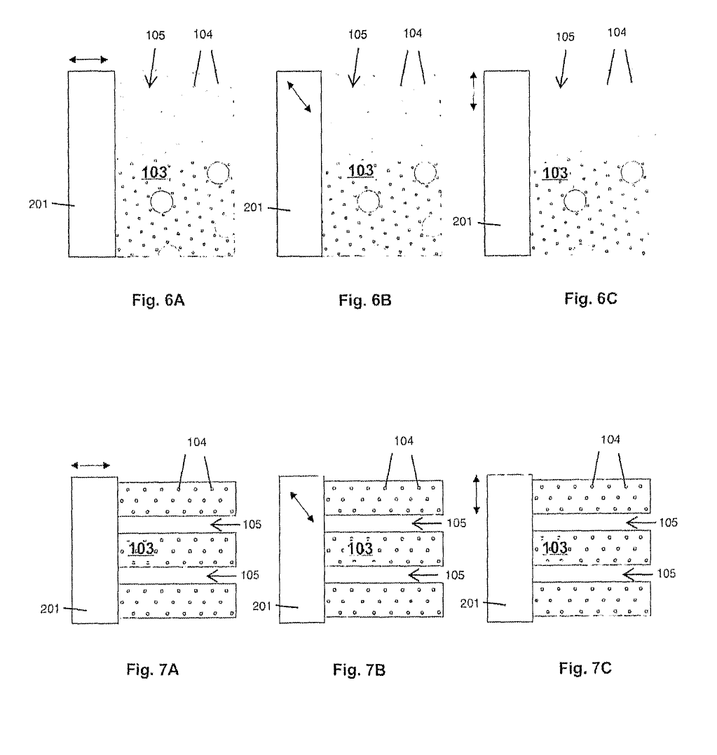

FIGS. 6A, 6B and 6C as well as 7A, 7B and 7C show different alternatives according to the invention for arranging the edge control strip 201 of the impingement dryer.

In the applications shown in FIGS. 6A, 6B and 6C there are circular blow openings 104 in the blow surface 103, and circular exhaust openings 105, which to their surface area are remarkably larger. Both the blow and the exhaust openings are placed relatively evenly over the area of the entire blow surface 103. The blow and exhaust openings are arranged into rows, which are slightly diagonal in relation to both the longitudinal direction of the machine and to the cross machine direction. In this way the blows and suctions are made as even as possible. The blow and exhaust openings can also be arranged in another manner, for example in straight rows.

In the applications shown in FIGS. 7A, 7B and 7C there are circular blow openings 104 in the blow surface 103. The blow openings 104 are arranged in bars 108, which are in the cross machine direction, substantially evenly over the area of the entire bar. Suction gaps 105 functioning as exhaust openings, which are in the cross machine direction, are left between the bars.

In the applications shown in FIGS. 6A and 7A the blows and suctions in the edge area of the impingement dryer are controlled by moving the edge control strip 201 in the cross machine direction in relation to the blow surface 103. The edge control strip 201 can in these cases be a simple solid plate or a perforated plate, which has an aperture pattern designed especially according to the location and size of the blow openings 104 and suction openings 105 of the blow surface.

In the applications shown in FIGS. 6B and 7B the blows and suctions in the edge area of the impingement dryer are controlled by moving the edge control strip 201 in relation to the blow surface 103 diagonally both in relation to the cross machine direction and the machine direction. The edge control strip 201 can in these cases be for example a simple solid plate or a perforated plate, which has an aperture pattern designed especially according to the location and size of the blow openings 104 and suction openings 105 of the blow surface.

In the applications shown in FIGS. 6C and 7C the blows and suctions in the edge area of the impingement dryer are controlled by moving the edge control strip 201 in the machine direction in relation to the blow surface 103. In this solution the covering of the blow openings 104 and the suction openings 105 can be realized with a strip 201, which has an aperture pattern designed especially according to the location and size of the blow openings 104 and suction openings 105 of the blow surface.

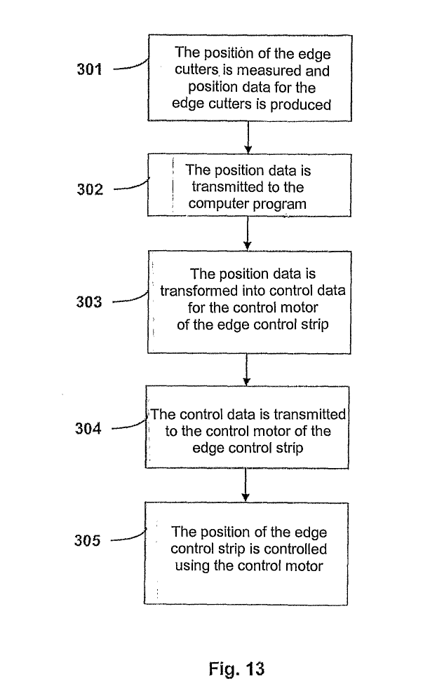

The movement of the edge strips 201 according to the invention can be controlled manually, either by hand or with a control motor, for example with a step motor. The movement of the edge strips 201 can also be controlled with an automatic control system. The automatic control system can be realised for example by connecting the motors which control the position of the edge strips 201 for example to the position of the edge cutters, which delimit the edge of the web 50. The control motors thus move the edge strip 201 to an area, which is optimal in relation to the position of the edge cutters. The function of an example of an automatic control system is shown in FIG. 13.

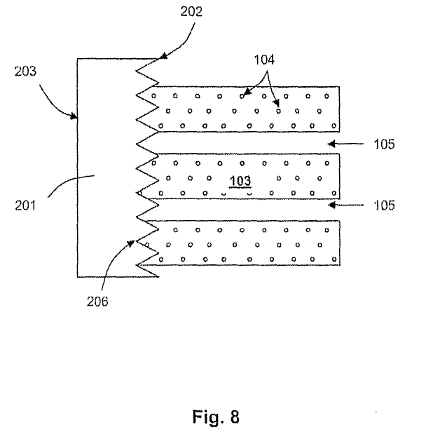

FIG. 8 shows an application of an edge control strip 201, where particular shapes 206, such as indentations or cuts are formed in the first edge of the strip 201, i.e. in the edge 202 toward the central line of the machine, for preventing tensions and distortions, which temperature differences cause in the strip. In FIG. 8 the edge control strip is arranged to be movable in the machine direction. It is possible to arrange said indentations or cuts 206 also in the second edge 203 of the strip.

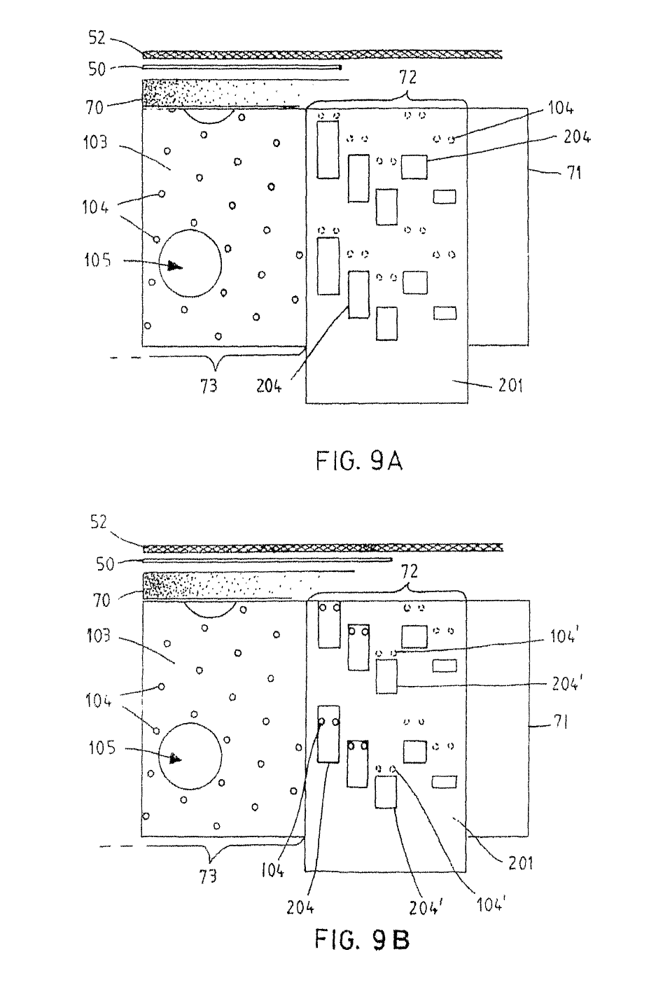

FIGS. 9A and 9B show an edge strip 201 meant to be moved in the machine direction, which edge strip has an aperture pattern designed especially according to the location and size of the blow openings 104 and exhaust openings 105 of the blow surface 103. The width of the support fabric and the width of the web 50 to be dried beneath it are shown in the top edge of the figures. Underneath it is shown with a varyingly coloured line 70 the amount of thermal energy in the blow air hitting the web. On the left in the figure, in the area of the uncovered blow surface 103, the colour of the line 70 is dark, depicting a large amount of hot air hitting the web 50. When moving to the right in the figure, toward the edge 71 of the dryer, the line fades, depicting how the amount of hot blow air hitting the web 50 decreases toward the edge. The object is to control the blow width of the impingement dryer so that hot air is not blown towards the bare support fabric 52. Thus the figures show how the edge strip 201 is placed so that at least some of the web 50 to be dried, for example 10-100 mm, is in a normal running situation always left underneath the edge strip 201.

In the situation in FIG. 9A the edge strip 201 covers all the openings in the blow surface 103 beneath it. The hidden blow openings 104 have however been drawn with dotted lines to be visible in the figure. The blow openings 104 in the edge part of the blow surface 103 underneath the edge strip define the first blow opening zone 72. The blow openings in the middle part of the blow surface define the second blow opening zone 73. The blow openings in the second blow opening zone cannot be covered with the edge control strip 201. In the situation in FIG. 9B the web 50 to be dried is slightly wider than in the situation in FIG. 9A, whereby the web 50 extends somewhat closer to the edge 71 of the dryer. In FIG. 9B the edge strip 201 has been moved a short distance in the machine direction, upwards in the figure. Now blow openings 104 have appeared from underneath some openings 204 in the edge strip 201, whereby hot air is blown in the situation in FIG. 9B slightly wider that in the situation in FIG. 9A. If the edge strip 201 was moved slightly further upwards as compared to the situation in FIG. 9B, the next blow openings 104′ of the blow surface would appear from the openings 204′. Because of the particular perforation of the edge area of the blow surface 103 and particularly formed openings 204 in the edge strip 201, the openings 104 appearing from underneath the edge strip are not in a straight row. Thus stripes, which are caused by the blowing, or uneven drying in the edge area of the web 50 are avoided.

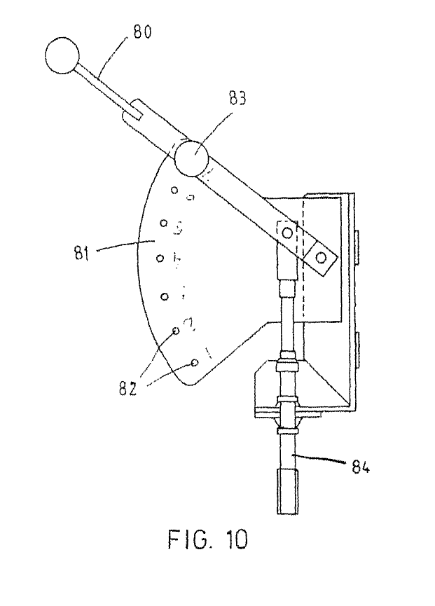

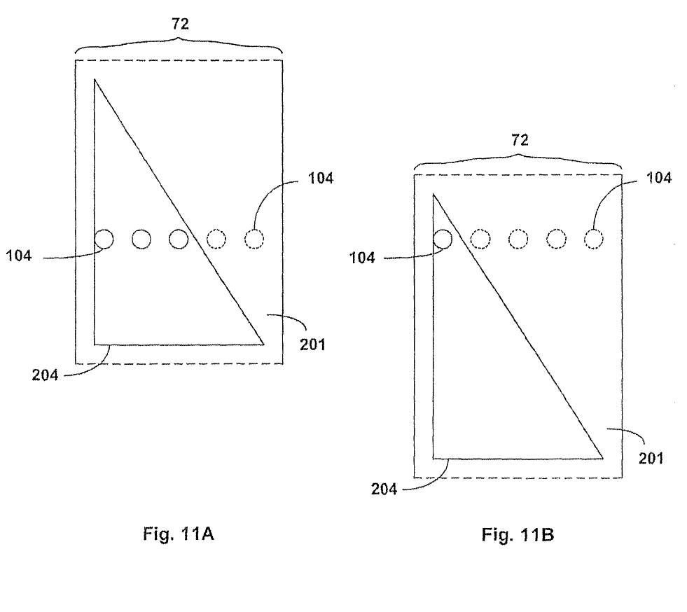

FIG. 10 shows a lever 80, which can be put in several, in the figure seven different positions due to the apertures 82 in the support plate 81 and the suspended peg 83, which fits into the apertures, which peg is connected to the lever. A cable wire 84 is connected to the lever 80, which cable wire is at its other end connected to the edge strip 201 according to the invention, in order to move it according to the invention. The lever 80 can be arranged to move the cable wire 84 and the edge strip 201 in desired steps, for example steps of 10-50 mm or 20-35 mm. The gradation can be adjustable as desired. The lever 80 and the edge strip 201 can also be arranged to be controlled in a stepless manner.

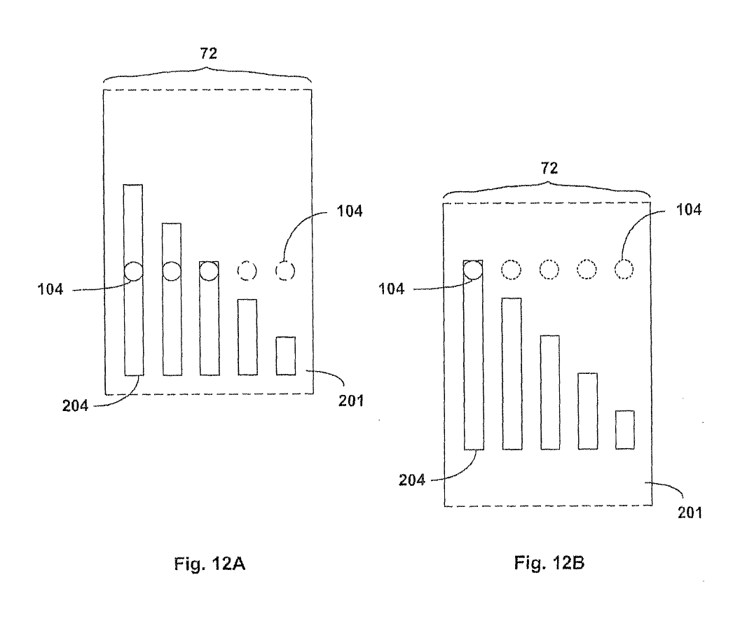

FIGS. 11A and 11B show an edge strip 201 meant to be moved in the machine direction, i.e. vertically in the figure, which has an aperture pattern designed especially according to the location and size of the blow openings 104 of the first blow opening zone 72 of the edge part of the blow surface. The blow openings 104 are placed in a row, which is in the cross machine direction. A triangular opening 204 is formed in the edge strip. When the edge strip 201 is moved in the machine direction, upwards in the figure, more openings 104 of the blow surface always appear in the opening 204 of the edge strip, thus increasing the blowing in the first blow opening zone 72. In FIG. 11A there are three blow openings 104 at the opening 204 in the edge strip. The blow openings 104 beneath the edge strip 201 have been drawn with a dotted line. In FIG. 11B the edge strip has been moved slightly downwards in the figure, whereby only one blow opening 104 is still at the opening 204. If the edge strip 201 was moved slightly further downwards, that last blow opening 104 would also be covered, whereby no blowing would be maintained in the first blow opening zone 72.

The example in FIGS. 12A and 12B corresponds functionally to the example in FIGS. 11A and 11B. The difference is that the several separate openings 204 of different lengths, which openings are elongated in the machine direction, have now been formed in the edge strip 201. Each opening 204 has been aligned with each of the blow openings 104 of the blow surface. The openings 204 of different length align in turns with the blow openings 104 when the edge strip 201 is moved in the machine direction. In FIG. 12A three blow openings 104 are visible in the openings 204, and in FIG. 12B only one.

FIG. 13 shows the function of a control system for the position of an edge control strip according to the invention as a simplified flow chart. FIG. 14 is a schematic block diagram of the control system. The following description of the function of the control system refers to reference characters in FIGS. 13 and 14. The purpose of the control system is to move the edge strip to an optimal area in relation to the position of the device which delimits the fibre web, such as the edge cutter. In stage 301 the position of the edge cutters, which delimit the edge of the fibre web, is measured by a sensor 401. Edge cutters are known as such, and they will not be presented in this text in further detail. The sensor is mechanically connected to the edge cutters, so that anytime the edge cutters move the sensor senses the movement of the edge cutters via the mechanical contact. Thus the sensor 401 produces measurement data regarding the position of the edge cutters, i.e. so-called position data. In stage 302 the position data produced by the sensor 401 is transmitted to a computer 402 for example via an electric wire. In stage 303 a computer program 403 in the memory of the computer, into which computer program calculation data has been fed, such as mathematical equations, with the aid of which the effect of different positions of the edge cutters on the optimal position of the edge control strip can be calculated. Based on the obtained position data and the calculation data the computer program 403 produces control data needed by the control motor 404 for controlling the position of the edge control strip. In stage 304 the produced control data is transmitted to the control motor 404 for example via an electric wire. In stage 305 the control motor 404 moves the edge control strip 201 a necessary amount in the necessary direction based on the control data.

Figures show only some preferred exemplary embodiments according to the invention. Facts of secondary importance with regards to the main idea of the invention, facts known as such or evident for a person skilled in the art, such as power sources or support structures possibly required by the invention, are not separately shown in the figures. It is apparent to a person skilled in the art that the invention is not limited exclusively to the examples described above, but that the invention can vary within the scope of the claims presented below. The dependent claims present some possible embodiments of the invention, and they are not to be considered to restrict the scope of protection of the invention as such.

1.-27. (canceled)

28. A method for reducing runnability problems caused by gas flows in an impingement dryer for a fibre web in a paper machine, the dryer having gas blowing means and gas exhaust means, said method comprising:
supporting the fibre web to be dried with a support fabric;
moving the support fabric and the fibre web to be dried in a machine direction through a first end of the impingement dryer past the blowing means and exhaust means and out through a second end of the impingement dryer, the support fabric and the fibre web being at least partially supported by several rolls or cylinders, which rotate around axes, and which are transverse to the paper machine;
blowing hot gas from the blowing means towards the fibre web to be dried,
removing gas from a vicinity of the fibre web to the exhaust means,
moving at least one edge control strip in the machine direction edges of the impingement dryer in front of at least one of the blowing means and the exhaust means, so that a desired number of the at least one of the blowing means and the exhaust means is covered, thereby controlling the effect of the blowing means and the exhaust means.

29. The method according to claim 28, the impingement dryer having a blow surface forming blow openings of the blowing means and exhaust openings of the exhaust means, wherein the step of moving at least one edge control strip comprises moving the at least one edge control strip in a direction of the blow surface.

30. The method according to claim 29, wherein the step of moving the at least one control strip comprises moving the at least one edge control strip between the blow surface and the fibre web to be dried.

31. The method according to claim 29, wherein the step of moving the at least one control strip comprises moving the at least one edge control strip on the side of the blow surface opposing the fibre web to be dried on a blow chamber facing side of the blow surface.

32. The method according to claim 29, wherein the at least one edge control strip is movable to different positions, and the at least one edge control strip covers substantially only blow openings or substantially only suction openings in each of the different positions.

33. The method according to claim 28, further comprising controlling movement of the fibre web inside the impingement dryer using runnability components including at least one or blow boxes and suction boxes.

34. The method according to claim 28, wherein the at least one edge control strip is inclined at an inclination of 0.1-2 degrees in relation to the machine direction in order to account for narrowing of the fibre web due to drying.

35. The method according to claim 28, wherein the step of moving the support fabric and the fibre web comprises transporting the fibre web to be dried in the impingement dryer with unsupported draw in the sections between the rolls or cylinder, such that the fibre web is transported mainly with unsupported draw.

36. The method according to claim 28, wherein the step of moving at least one edge control strip comprises controlling the movement of the at least one edge control strip manually by hand or manually with a control motor.

37. The method according to claim 28, wherein the step of moving at least one edge control strip comprises controlling the movement of the at least one edge control strip with an automatic control system.

38. The method according to claim 37, wherein the step of moving at least one edge control strip comprises:
monitoring a location of the edge of the fibre web to be dried or a position of devices that delimit the edge with a sensor that produces measurement data for the edge;
transforming the measurement data received from the sensor into control data for a control motor;
controlling, using the control data, the control motor, which controls the movement of the at least one edge control strip; and
moving the at least one edge strip in order to place the at least one edge strip in an optimal place in relation to the location of the edge of the fibre web to be dried.

39. The method according to claim 37, wherein the step of moving at least one edge control strip comprises:
monitoring a position of edge cutters, which delimit the edge of the fibre web to be dried, with a sensor that produces measurement data of the edge of the fibre web to be dried based on position data for the edge cutters;
transforming the position data received from the sensors into control data for a control motor;
controlling, using the control data, the control motor, which controls the movement of the at least one edge control strip; and
moving the at least one edge strip in order to place the at least one edge strip in an optimal place in relation to the location of the edge of the fibre web to be dried.

40. An impingement dryer for drying a continuous fibre web supported by a support fabric and moving in the machine direction, said impingement dryer comprising:
a first end and a second end, which extend essentially across a machine direction, and edges extending essentially in the machine direction;
gas blowing means and gas exhaust means;
several rolls or cylinders arranged to rotate around their longitudinal axes, which are transverse to the machine direction, and arranged to define a path, the support fabric and the fibre web to be dried are arranged to travel along the path on said several rolls or cylinders into the impingement dryer through the first end, inside the impingement dryer past the blowing means and the exhaust means, and out through the second end of the impingement dryer; and
an edge control strip arranged in one of the machine direction edges of the impingement dryer, said edge control strip being movable in front of the blowing means and the exhaust means at the edge area to a desired position, to selectively cover at least one of the blowing means and the exhaust means in a desired manner to control the effect of the blowing means and the exhaust means, to thereby reduce the runnability problems caused by gas flows.

41. The impingement dryer according to claim 40, further comprising a blow surface parallel to the path of the fibre web to be dried and forming blow openings of the blowing means and exhaust openings of the exhaust means, the edge control strip being arranged to be moved in the direction of the blow surface.

42. The impingement dryer according to claim 41, wherein the edge control strip is arranged to be moved between the blow surface and the path of the fibre web to be dried.

43. The impingement dryer according to claim 41, wherein the edge control strip is movable on the side the blow surface opposing the fibre web to be dried on a blow chamber facing side of the blow surface.

44. The impingement dryer according to claim 41, wherein the at least one edge control strip is movable to different positions, and the at least one edge control strip covers substantially only blow openings or substantially only openings in each of the different positions.

45. The impingement dryer according to claim 40, further comprising runnability components proximate the path of the fibre web to be dried, the runnability components comprising at least one of blow boxes and suction boxes arranged for controlling the movement of the fibre web.

46. The impingement dryer according to claim 40, wherein the edge control strip is arranged at an inclination of 0.1-2 degrees in relation to the machine direction in order to take into account the narrowing of the fibre web due to drying.

47. The impingement dryer according to claim 40, wherein the fibre web to be dried is arranged to be transported in the impingement dryer with unsupported draw in the sections between the rolls or cylinders, such that the fibre web is transported mainly with unsupported draw.

48. The impingement dryer according to claim 40, wherein cuts or indentions are arranged in the edge of the edge control strip for reducing thermal tensions.

49. The impingement dryer according to claim 41, wherein the blow openings arranged in the edge part of the blow surface are not situated in straight lines in the machine direction or the cross machine direction.

50. The impingement dryer according to claim 41, wherein the blow openings in the blow surface are arranged into at least two zones, which are elongated in the machine direction, a placement of the blow openings differs from each other in the different zones,
the first blow opening zone is defined by the blow openings in the edge part of the blow surface, of which openings the edge control strip is arranged to cover a desired number, and
the second blow opening zone is defined by the blow openings in the middle part of the blow surface, which openings cannot be covered with the edge control strip.

51. The impingement dryer according to claim 13, wherein the edge control strip is arranged to be moved manually by hand or manually by a control motor.

52. The impingement dryer according to claim 13, further comprising an automatic control system arranged to move the edge control strip.

53. The impingement dryer according to claim 52, further comprising:
at least one sensor arranged to monitor the location of the edge of the web to be dried or the position of the devices which delimit the edge, and which sensor is arranged to produce measurement data for the edge;
a control device for transforming the measurement data received from the sensor into control data for the control motor; and
data transfer means for forwarding the measurement data from the sensor to a computer and for transferring the control data to the control motor, which controls the movement of the edge control strip.

54. The impingement dryer according to claim 52, further comprising:
at least one sensor arranged to monitor the position of edge cutters which delimit the edge of the web, said sensor being arranged to produce measurement data for the edge, which is position data for the edge cutters;
a control device for transforming the position data received from the sensor into control data for the control motor; and
data transfer means for forwarding the position data from the sensor to the computer and for transferring the control data from the computer to the control motor, which controls the movement of the edge control strip.
